(19) United States
(12) Patent Application Publication
(10) Pub. No.: US 2002/0047107 A1
(43) Pub. Date: Apr. 25, 2002

(54) Method for forming a product sensor

(75) Inventors: Timo Lindstrom, Tampere (FI); Marko Hanhikorpi, Pirkkala (FI); Juhani Stromberg, Tampere (FI); Samuli Stromberg, Tampere (FI); Mikko Tirkkonen, Tampere (FI)

Correspondence Address: FITCH EVEN TABIN AND FLANNERY, 120 SOUTH LA SALLE STREET, SUITE 1600, CHICAGO, IL, 60603-3406, US

(73) Assignee: UPM-KYMMENE CORPORATION

(21) Appl. No.: 09/902,451

(22) Filed: Jul. 10, 2001

Related U.S. Application Data
(63) Continuation of application No. PCT/FI00/00021, filed on Jan. 13, 2000.

(30) Foreign Application Priority Data
Jan. 14, 1999 (FI) 990055

(51) Int. Cl. H01C 1/00

(52) U.S. Cl. 252/500

(57) ABSTRACT

A method for making a product sensor by printing, preferably by serigraphy. Conductive ink is used, at least in part, in the printing. The product sensor is made by printing at least two conductive layers, with at least one insulating layer printed in between them. The invention further relates to a product package incorporating a product sensor with at least two conductive layers and at least one insulating layer formed in between them. At least one insulating layer is made by printing.

The present invention relates to a method of forming a product sensor by printing, preferably by serigraphy, with the printing done at least in part with conductive ink. The present invention further relates to a product package comprising a product sensor, and a product sensor which is made by printing, preferably by serigraphy, the printing being done at least partly with conductive ink.

In the following, the term product sensor refers to an electrical connection formed in a product or a product package, potentially to be used for product identification, such as for product protection against theft (anti-theft sensor), or, as a detecting means for identifying the product/user. Furthermore, in the following, the term product sensor refers to various smart cards, such as travel tickets, admission tickets, access control passes, and other identification cards.

Product protection sensors, usually provided with a self-adhesive label (self-adhesive product protection label), are used in conjunction with products to prevent possible attempts at theft of the product. Products are fitted with product sensors, and at store exits there are detectors which can identify such product sensors. The product sensor is deactivated when the product is appropriately paid for at the cash desk. The detectors do not as a rule detect a deactivated sensor, and unnecessary alarms are thus avoided.

Product sensors of this kind are usually manufactured of thin plastic film, which is coated on either side with aluminium foil by laminating. Printing ink is then applied to the aluminium foil, preferably by the gravure technique, wherein by corroding the metal, e.g. by etching, a metal pattern is left to enable the formation of the required circuit, usually a resonance circuit consisting of one or more coils and a capacitor. Recycling etched metal for reuse is difficult and expensive. Even if part of the metal could be recovered for reuse, the etching process generates waste products harmful to the environment, requiring appropriate storage. Manufacturing by etching does not allow targeted manufacture. Printing with conductive ink is not possible in conjunction with a sensor made by etching, because the known conductive inks do not withstand the etching bath; therefore printing the fuse is not possible, or it has to be printed after etching.

Furthermore, it must be possible to deactivate the product sensor as easily as possible, thus ensuring that the person who has appropriately bought the product to which the product sensor has been attached will not cause unnecessary alarms when exiting the store.

The deactivation of such product sensors usually entails breaking a conductor wire within the resonance circuit, or causing a short circuit between the capacitor boards in the resonance circuit. In a product sensor based on the breaking of the conductor wire there is a conductor wire preferably with a weakened part, where the conductor will break when the sensor is exposed, at resonance frequency, to an electromagnetic field exceeding a certain predetermined minimum power level.

Further, there are known product sensors which can be activated prior to use, thus enabling the attachment of product sensors to products already at the manufacturing stage, which makes product protection against theft easier and faster. The activation is based on the use of e.g. two resonance frequencies, in which case the non-activated sensor does not resonate at identification frequency. In such a case activation is effected by changing the resonance frequency, e.g. by breaking a conductor wire in a resonance circuit, thereby changing the resonance frequency.

Prior art product protection self-adhesive stickers are attached either to the product or the product package. This is done either manually or with a machine made for the purpose. The fixing of the stickers therefore raises the manufacturing costs of the product. Furthermore, procuring the stickers is a process of its own.

In many cases, the product protection sticker is preferably to be attached in a place that is not easily discernible. In such a case, any inappropriate deactivation of the sticker is easier to prevent than it would be, were the sticker to be placed in a visible spot. It is not easy or even possible in all products, to place the product protection sticker unnoticeably, in which cases the product protection sticker is easily detectable.

Further, there are known product sensors which incorporate a plastic film, with electrical conductors printed on both sides to form capacitors and a coil. In this case, the thickness of the insulating layer and the electrical characteristics are essentially the same throughout the sensor. The thickness of the plastic film cannot be reduced indefinitely, so that the space needed for the coils and capacitors cannot be significantly reduced if the electrical circuit diminished is to function properly. One of the problems in this solution is that the conductivity of the ink by itself is not enough to ensure that a reliably functioning electrical circuit, suitable particularly for product sensor applications, can be made by printing. The conductivity can to some degree be enhanced by adding conductive particles to the paste used as printing ink. Neither can the conductivity be significantly enhanced without excessively weakening the elasticity of the printed conductor and its adhesion to the plastic film. Furthermore, the more conductive particles there are in the paste, the more expensive it is. This means that the manufacturing costs of the product sensor also increase. A further problem with conductive inks is that the plastic materials used in the insulating layers cannot withstand the high drying temperatures needed for conductive inks.

One of the purposes of the present invention is to eliminate, to the highest degree possible, the aforementioned drawbacks and to achieve a method for the protection of products and product packages. The method according to the present invention is characterised in that the product sensor is manufactured by printing at least two conductive layers between which at least one insulating layer is printed. A product package according to the present invention is characterised in that the product sensor has at least two conductive layers printed on it, with at least one insulating layer formed between them, and that at least one insulating layer is manufactured by printing. A product sensor according to the present invention is characterised in that the product sensor has at least two conductive layers printed on it, with at least one insulating layer formed in between them, and that at least one insulating layer is manufactured by printing. The invention is based on the idea that in a product sensor, such as a product protection sensor, one or more intermediate layers are manufactured by printing.

With the present invention marked advantages are obtained compared with the prior art methods and product packages. A product sensor made by printing according the present invention can easily be incorporated in a product package. Thus, the stages of procuring, storing and attaching product sensors can be avoided. By making the product sensor according to the present invention, its position on the product is not as significant as when using prior art stickers, as the product sensor can be made difficult to detect, e.g. by printing on top of it a further coat of covering, essentially non-conductive ink. An intermediate layer made according to the present invention by printing, can be made thinner than in sensors made according to the prior art, which again makes it possible to make the sensor coils and capacitors smaller and/or the coil to comprise e.g. several layers. Furthermore, at different points of the intermediate layers there can be parts with different mechanical and electrical characteristics, whereby, e.g. the deactivation of the sensor can be made more reliable and the characteristics of the capacitor can be improved in comparison to sensors made according to the prior art.

According to another preferred embodiment of the invention the product sensor can be a separate product sensor formed on the surface material of a label made of self-adhesive laminate or the like. A self-adhesive laminate of this kind preferably comprises a backing paper and a face paper. In product sensor embodiments made according to the prior art, the product sensor is usually laminated between these backing and face papers. The present invention enables the manufacture of a product sensor directly on the face paper, thereby lowering the costs of manufacturing the product sensor.

A further advantage of the printing method according to the present invention over the known etching technique is that less ink is used. Manufacturing costs can thus be reduced.

Also, in a product sensor according to the invention, the conductivity of the ink can be enhanced without increasing the amount of the conductive particles. Therefore, the sphere of application of the product sensor can be widened to include, e.g. smart card applications, an area in which a limiting factor was previously the insufficient conductivity of the ink.

The invention is described in the following in more detail, with reference to the appended drawings, in which

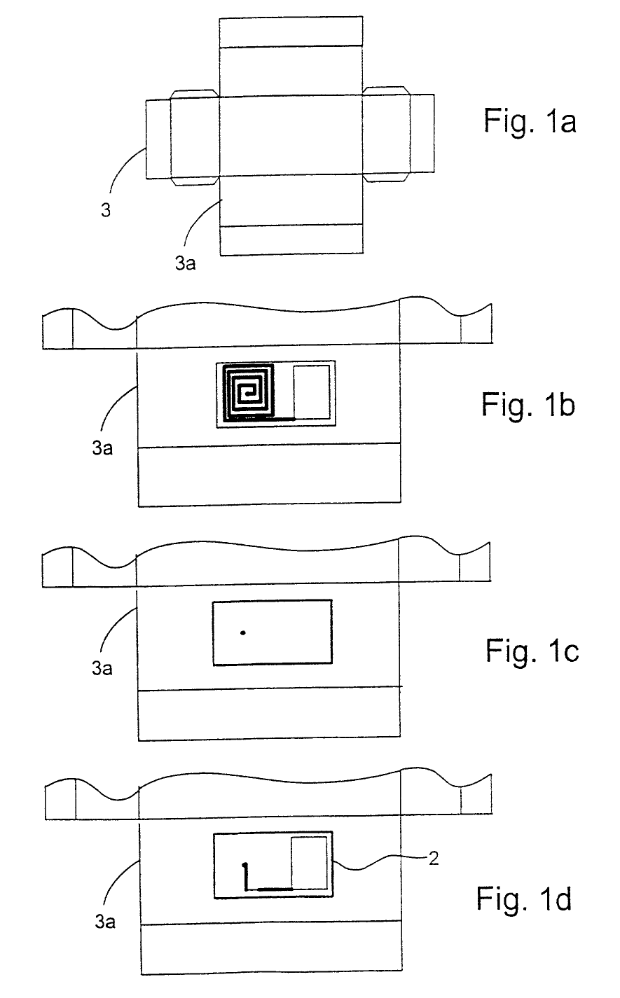

FIGS. 1a-1d show the different stages of a method relating to a preferred embodiment of the invention,

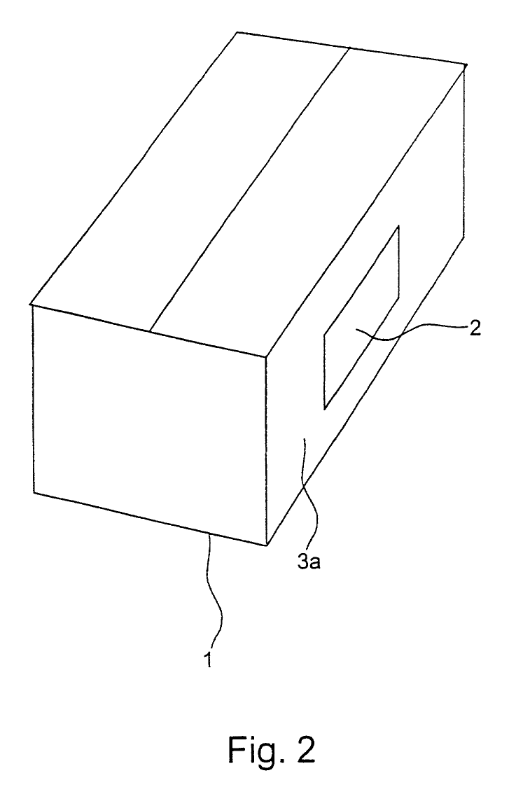

FIG. 2 is a perspective drawing of a product package according to a preferred embodiment, and

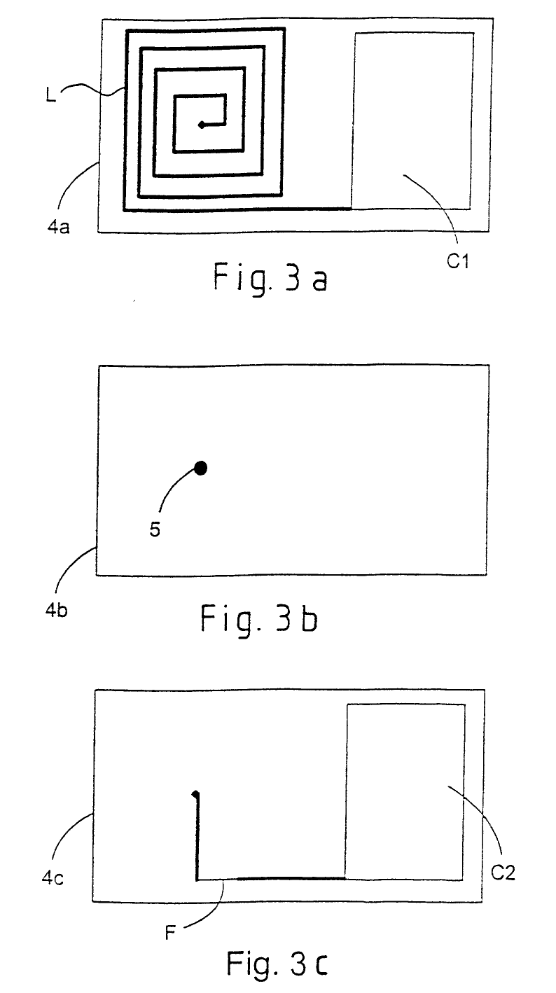

FIG. 3 shows some examples of printing frames used in a preferred embodiment of the method according to the present invention.

The following is a description of a preferred embodiment of the invention, where a product sensor 2 is formed in a product package 1. FIGS. 1a-1d depict the different stages of this process. FIG. 2 shows a product package 1 made according to this method.

For the manufacture of product sensor 2, preferably at least three printing frames 4a, 4b, 4c, have been formed, by means of which the needed conductor pattern is printed on the product package 1. FIG. 3 shows by way of examples such printing frames 4a, 4b, 4c. The printing is preferably done on the package blank 3, from which the product package 1 is formed. FIG. 1a shows the package blank 3 of the product package cut but not yet folded into a package. The blank in question is for a folding boxboard package. FIG. 1 depicts the packaging blank in such a way that the outer surface of the product package 1, to be formed of the packaging blank 3, is visible, whereby product sensor 2 is on the outer surface of the finished package; it is, however, clear that the product sensor 2 can also be formed on the inner surface of the package. FIGS. 1a-1d show the product sensor placed on the flap 3a, which forms one side wall 1a of the product package, but other parts of the product package 1 are equally applicable for the purpose. The crease lines of the package blank 3 are depicted by a broken line. To make the product sensor 2, the package blank 3 is fed into a printing machine (not shown), in which the first printing frame 4a has been placed. With the printing frame 4a, the first conducting layer is printed on the product sensor 2. In this example, the first layer consists of a coil, the first capacitor board and conductors. The coil is formed in the printing frame by the ink passing through the area represented by the reference letter L, and the first capacitor board is formed by the ink passing through the opening C1 and becoming attached to the surface of the package blank 3. FIG. 1b shows a detail of the situation after this first printing stage at the flap 3a of the package blank 3.

For the printing, an ink known as such is used. The printing method utilised is preferably the in itself known method of serigraphy, which facilitates an accurate printing result in relatively small detail. In the example shown in FIG. 3, the parts of the printing frames 4a, 4b and 4c in which the ink is able to pass through the printing frames 4a, 4b and 4c are represented by dark lines.

In the next printing stage the second printing frame 4b is placed in the printing machine to print the first intermediate layer of the conducting layers. In this case insulating printing ink is used. Lead-throughs can easily be formed in the insulating layer, thus forming a conducting connection between two conducting layers. One such lead-through is shown in the second printing frame 4b in FIG. 3 represented by the reference number 5. In addition, the thickness of the insulating layer can be made to vary from one place to another. For example, for the purposes of deactivation, a weakened point can be formed, which allows easy breakdown in connection with deactivation, causing a short circuit and thereby the deactivation of the product sensor. On the other hand, the deactivation can be effected by using a fuse, in which case, at the point where the fuse is located, the insulating layer is either thinner or there is an opening, which promote the melting of the insulating layer at the fuse due to the heat from the deactivation energy. FIG. 1c shows a detail of the situation at the flap 3a of the package blank 3 after the second printing stage.

After printing the insulating layer, the second conducting layer is printed. For this stage, the third printing frame 4c and conductive ink are used. At this stage, the second capacitor board is formed by the ink passing through the opening C2 and adhering to the surface of the insulating layer, and also the conductor between the second capacitor board and the lead-through. In this conductor there is preferably a thinner conductor formed, functioning as a fuse (represented by reference letter F). With this fuse, the product sensor 2, used as a product protection device, can be deactivated by methods known as such. FIG. 1d shows a detail of the situation after the third printing stage at flap 3a of the package blank 3, with the product sensor 2 according to this preferred embodiment, already incorporated on the surface of the package blank 3.

The product sensor 2 according to the invention can be made to have more intermediate layers than the one insulating layer described above. In this case, the area of the product sensor can be made smaller, as in this version, the coils can be formed of several wirings in overlapping layers. This also enhances the quality (Q-factor) of the coil. In a multi-layer sensor it is also easier to form several circuits resonating at different frequencies, which enables multi-frequency sensor applications. Such multilayer sensor applications are, for example, a product sensor which has two resonance circuits, one of which is used, at the first frequency, as a product protection sensor, and the other resonance circuit is used, at the second resonance frequency, as an identifying means, such as a product ID-identifier.

In a product sensor according to the invention, insulating materials of different electric and/or mechanical characteristics can be utilised in different insulating layers. Thus, e.g. for the insulating layer between the capacitor boards, a dielectric material most suitable in relation to the characteristics of the capacitor can be used. In printing, the thickness of the insulating layer can be more easily controlled than in prior art solutions, thereby allowing smaller manufacturing tolerances. This also makes it possible, e.g. in RF-ID applications (RF-ID, Radio Frequency Identification), in which a capacitor is used in conjunction with an identification circuit or an escort memory, for such a capacitor to be made using the printing technique according to this invention.

The printing technique also enables the fuse to be made from a different material than that used in the other conductors, such as the coil conductors. In this case, the fuse can be printed using a conductive ink with a lower melting point in relation to resistivity. This means that the fuse can be made smaller in volume compared with product sensors according to the prior art, thus facilitating easier breaking of the fuse. The cross-sectional area of the fuse can also be made smaller than the cross-sectional area of other conductors.

Similarly, several resonance circuits can be formed in a product sensor according to the invention, thereby also allowing activation to be arranged in the product sensor. The activation can be effected in the same way as the deactivation, e.g. with a fuse or a breakdown point (not shown). In this case, the product sensor can be taken to, e.g. a shop where the activation takes place and the deactivation takes place at the sale of the product. In a product sensor according to the invention, the reliability of the fuse or the breakdown point functioning as an activating means can be enhanced by weakening the insulating layer at the activating means.

It is obvious that the product sensor 2 can, within the scope of the invention, if necessary, be provided with more conducting and insulating layers constructed according to the principles described above.

When the printing stages needed to make the product sensor 2 have been executed, a further insulating layer for protection can be printed on top of the product sensor 2.

In this case, the effects of possible environmental conditions, such as humidity, will not be able to damage the product sensor so easily. On the other hand, the product sensor 2 can be made difficult to detect by printing a covering layer on top of it.

On the package blank 3, markings can be printed, such as the name of the manufacturer and information on the product packed in the product package 1. These markings can be made either independently of the manufacturing of the product sensor, or the markings can be formed in the printing frames 4a, 4b and 4c, in which case the product sensor 2 and the markings are made, at least in part, simultaneously. This serves to decrease the number of work phases required for making the product package.

It is obvious that there may be more than one package blank 3 being printed simultaneously. In this case, each phase is repeated for each package blank before the next phase is carried out. The printing frames 4a, 4b and 4c can also be copied, in which case several package blanks 3 can be printed at one printing.

In the above, the invention was described in conjunction with the manufacturing of the product package 1. The invention can also be adapted so that the product sensor 2 is manufactured directly onto the product, in which case the above-mentioned phases are adapted in such a way that the printing is done on the surface of the product. This method can be utilised, for example, on such products as are displayed without a product package. Such products include books, in which the product sensor can be printed by the method according to the invention, either on the cover or on the inside cover.

According to another preferred embodiment of the invention, the product sensor is printed, as a separate product sensor, on the face material of a label made of self-adhesive laminate or such. The label can be printed by methods known as such with the desired markings, such as product information, information on the manufacturer, etc. Preferably after the making of the self-adhesive laminate, the product sensor is printed on the label according to the principles of the preferred embodiment of the invention described above. This label, incorporating the product sensor according to the invention, can then be attached to the product package in the desired place. The label can also be attached directly to the product. Using this embodiment of the product sensor, neither the product package 1 nor its manufacture require modification, and the manufacturing process of the product sensor can be combined with the manufacture of the labels, thereby enabling the speedy manufacture of a large number of labels incorporating the product sensors. On many products, product information is, in any case, printed on a separate self-adhesive label, and therefore the incorporation of a product sensor in such a self-adhesive label can be advantageously arranged.

A product sensor according to a third preferred embodiment of the invention is manufactured as a separate product sensor to be placed on a separate attachment base (not shown). After this, the base is attached to the product, the product package 1, or the label made of self-adhesive laminate. The invention is applicable to, e.g. product packages for household appliances, CD disks, DVD disks, disk cases, magazines, cigarette packages, etc.

The conductivity of the ink used in the manufacture of the product sensor 2 according to the invention can if necessary be enhanced as follows. Upon printing (during or after printing), a greater pressure is exerted on the product sensor, preferably as a linear load, simultaneously raising the temperature to some degree. This will cause the ink to be compressed more densely, thereby bringing the conductive particles closer to one another. This in turn will enhance the conductivity of the ink. This deformation is not reversible to any great degree, and therefore the product sensor will have permanently enhanced conductivity. For this reason, the product sensor can also be used in such products where the product sensor is not necessarily used as a product protection device, but for other identification purposes, e.g. as a remote identification card. Such applications include travel tickets, admission tickets, passes for access control applications, library cards, escort memory applications, etc. In this case, the product sensor 2, printed on a remote identification card according to the invention, comprises an identification circuit and/or an escort memory. This identification circuit (not shown) contains information, e.g. on the uses of the travel ticket and the amount of unused credit still on the card. An identification circuit of this kind can be attached to the card using the flip-chip technique, known as such.

The enhancement of the ink conductivity by increased pressure can be effected for example in the course of calendering, even though other solutions where pressure is applied to the ink and the temperature raised are also feasible. Another method for improving the conductivity of the ink is electrolysis. In electrolysis, conductive metal is applied to the surface of the printed conductors, thereby enhancing the conductivity.

In smart card applications, energy and/or information is transmitted by means of an antenna built into the smart card. With better conductivity, dissipation can be reduced in the coil used as the antenna of such an RF-ID card, which will in turn reduce e.g. energy transfer loss.

The present invention is not limited to the embodiments described in the above, but it may be modified within the scope of the attached patent claims.

What is claimed is:

1. A method for forming a product sensor comprising printing at least two conductive layers with at least one insulating layer printed on between them, wherein conductive ink is used at least partly in the printing.

2. A method according to claim 1, in which the product sensor is used in conjunction with a product or a product package, wherein the product sensor is printed on the product, on the product package or on the face material of a label made of self-adhesive laminate.

3. A method according to claim 2, in which markings such as information on the product are printed on the product package, wherein the product sensor is manufactured in connection with the printing of markings on the product package.

4. A method according to claim 2, wherein the product sensor is printed separately on an attachment base which is attached to the product, the product package, or a label made of self-adhesive laminate.

5. A method according to claim 1, wherein the conductivity of the ink is enhanced in the process of printing the product sensor.

6. A method according to claim 5, wherein the conductivity of the ink is enhanced by exerting pressure at least on the conductive ink and raising the temperature at least of the conductive ink.

7. A method according to claim 6, in which calendering is utilized in manufacturing the product sensor, wherein the conductivity of the ink is enhanced in the process of calendering.

8. A method according to claim 5, wherein the conductivity of the ink is enhanced by electrolysis.

9. A product package, comprising a product sensor manufactured by printing, using, at least in part, conductive ink, wherein at least two conductive layers have been printed on the product sensor, with at least one insulating layer formed in between them, and wherein the at least one insulating layer is made by printing.

10. A product package according to claim 9, wherein the product package is a folding boxboard package.

11. A product package according to claim 9, wherein the product package is a cigarette package, a digital video disc, a compact disc, a case for a digital video disc, or a case for a compact disc.

12. A product sensor manufactured by printing, in which conductive ink is used, at least in part, for the printing, wherein the product sensor comprises at least two printed conductive layers with at least one insulating layer formed in between them, and that at least one insulating layer is made by printing.

13. A product sensor according to claim 12, wherein the product sensor is printed on a product, a product package, or on a face material of a label made of self-adhesive laminate.

14. A product sensor according to claim 12, wherein the product sensor is made to be used as a product protection sensor.

15. A product sensor according to claim 14, in which a deactivation means, such as a fuse, has been formed on at least one conductive layer to deactivate the product sensor, wherein the fuse is made of a material other than that of other wirings in the conductive layer.

16. A product sensor according to claim 14, in which a deactivation means, such as a fuse, has been formed to deactivate the product sensor, wherein a thinner part or an opening has been made in an intermediate layer at a point where the said deactivation means is located.

17. A product sensor according to claim 16, in which a deactivation means, such as a fuse, has been formed on at least one conductive layer to deactivate the product sensor, wherein the fuse is made of a material other than that of other wirings in the conductive layer.

18. A product sensor according to claim 14, in which also an activation means has been formed to activate the product sensor, wherein a thinner part or an opening has been made in an intermediate layer at the point where the said activation means is located.

19. A product sensor according to claim 12, wherein the product sensor has been made to function in a travel ticket, an admission ticket, or another remote identification card circuit.

20. A product sensor according to claim 19, wherein the product sensor comprises an RF-ID identification circuit.

21. A product sensor according to claim 19, wherein the product sensor comprises an escort memory.

22. A method according to claim 1, wherein the printing is done by serigraphy.
